(19) United States
(12) Patent Application Publication
(10) Pub. No.: US 2006/0201970 A1
(43) Pub. Date: Sep. 14, 2006

(54) Safety nozzle for aerosol can

(76) Inventor: Sidney J. Jasek, Pearland, TX (US)

Correspondence Address: John R. Casperson, P.O. Box 2174, Friendswood, TX, 77549, US

(21) Appl. No.: 11/078,780

(22) Filed: Mar. 11, 2005

(51) Int. Cl. B67B 5/00; B65D 83/14

(52) U.S. Cl. 222/153.11; 222/402.11

(57) ABSTRACT

A safety nozzle assembly for use on an aerosol can comprises a collar element and a button element. The collar element has an open lower end for closely fitting over the rim of the can. The button element has a plurality of radial protrusions or circumferentially extending slots on its outer surface which are engagable with an opposite plurality of radial protrusions or circumferentially extending slots on an inner surface of the collar element to prevent relative longitudinal movement between the collar element and the button element when the button element and the collar element are in a first rotational position with respect to each other and the protrusions are engaged with the slots. By rotating the button with respect to the collar, the protrusions can be disengaged from the slots and the button element then depressed to discharge pressurized contents from the can.

### BACKGROUND OF THE INVENTION

This invention relates generally to a safety nozzle assembly for use on an aerosol can.

Aerosol cans are used to dispense a wide range of products. Some of these products can be hazardous if dispensed into the user's face, or inhaled due to an accidental discharge. Small children, particularly, are vulnerable to accidently spraying themselves in the face with potentially hazardous substances from the cans, and could forseeably remove and choke on a conventional aerosol spray nozzle from a can. A spray nozzle assembly which reduces these risks would be desirable.

Over time, the design of the cans has become somewhat standardized. The base of the can is generally concave inwardly so that it will stably stand on its bottom rim in the upright position. The top of the can is generally domed, with an outer rim generally being formed where the dome attaches to the cylindrical can sidewall. The top of the dome carries a valve assembly, with an inner rim generally being present where the valve assembly attaches to the dome. A plastic nozzle is positioned in flow communication with the valve assembly to dispense the product via a plastic tube, which in some designs is carried by the valve assembly and in other designs is carried by the nozzle.

Large overcaps are mounted on the outer rim of some products, and small overcaps on the inner rim of other products. The overcaps protect against accidental discharge during shipment. Sometimes, the large overcaps are made difficult to remove, and this provides a safety factor for children. However, because of inconvenience, adults often do not replace such caps after use, leaving the can without its safety features.

A safety feature carried by the nozzle would be less likely to be defeated, and therefore more effective.

It is an object of this invention to provide a safety nozzle assembly to reduce the risk of injury from aerosol containers.

### SUMMARY OF THE INVENTION

In accordance with one embodiment of the invention, a safety nozzle assembly comprises a collar element and a button element. The safety nozzle assembly is for use on a pressurized aerosol container of the type having a generally centrally located valve assembly and a generally circular rim adjacent its upper end. The collar element has an open lower end for closely fitting over the rim, and an upper end which is partially closed by a generally annular upper end wall. The upper end of the collar element defines a circular opening. The button element has a generally cylindrical sidewall extending through the circular opening of the collar element. The button element has a flow passage therethrough having an axial portion leading to a nozzle inlet for connecting to the valve assembly and a radial portion leading to a nozzle outlet through which the aerosol spray may be directed by a user. The button element has a plurality of radial protrusions or circumferentially extending slots on its outer surface with are engagable with an opposite plurality of radial protrusions or circumferentially extending slots on an inner surface of the collar element to prevent relative longitudinal movement between the collar element and the button element when the button element and the collar element are in a first rotational position with respect to each other and the protrusions are engaged with the slots. By rotating the button with respect to the collar, the protrusions can be disengaged from the slots and the button element then depressed to discharge the pressurized contents from the can.

### BRIEF DESCRIPTION OF THE DRAWINGS

FIG. 1 is a side sectional view of an upper portion of an aerosol can carrying a safety nozzle in accordance with an embodiment of the invention.

FIG. 2 is a pictorial representation of an element of the invention shown in FIG. 1.

FIG. 3 is a pictorial representation of another element of the invention shown in FIG. 1.

FIG. 4 provides an inside view of the button assembly from the bottom side, partly in breakaway, with the elements arranged in a locked position.

FIG. 5 is a view from the perspective shown in FIG. 4 with the elements arranged in an unlocked configuration.

### DETAILED DESCRIPTION OF THE INVENTION

In one embodiment of the invention, there is provided a safety nozzle assembly 2 for use on a pressurized aerosol container 4 which has a generally centrally located valve assembly 6 and a generally circular rim 8 adjacent to its upper end. The safety nozzle assembly comprises a collar element 10 and a button element 12.

The collar element has an open lower end for closely fitting over the rim and an upper end which is partially closed by a generally annular upper end wall 14. The upper end defines a circular opening.

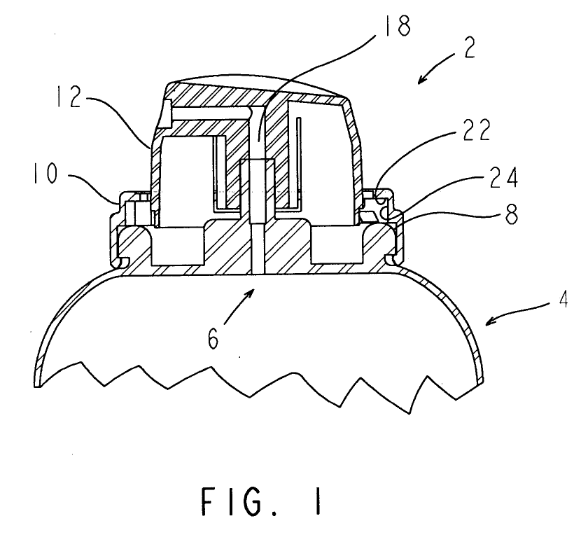

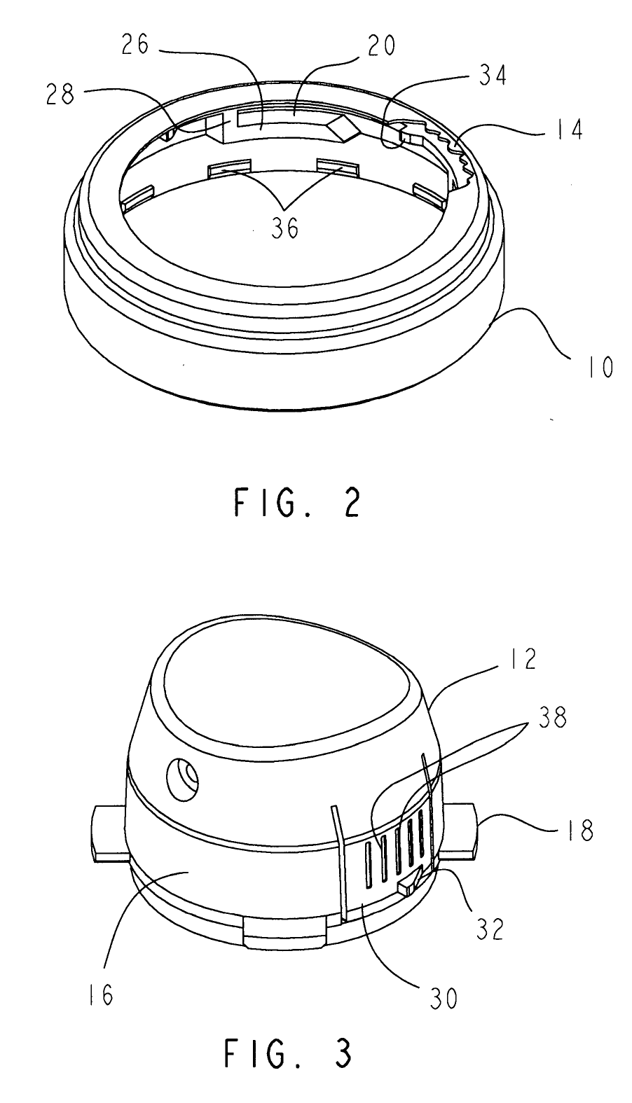

The button element has a generally cylindrical sidewall 16 extending through the circular opening of the collar element (see FIG. 1). The button element has a flow passage therethrough having an axial portion leading to a nozzle inlet for connecting to the valve assembly and a radial portion leading to a nozzle outlet through which the aerosol spray may be directed by a user.

The button element has a plurality of radial protrusions or circumferentially extending slots on its outer surface with are engagable with an opposite plurality of radial protrusions or circumferentially extending slots on an inner surface of the collar element to prevent relative longitudinal movement between the collar element and the button element when the button element and the collar element are in a first rotational position with respect to each other and the protrusions are engaged with the slots. In the illustrated embodiment, the button element is provided with a plurality of radial protrusions 18 and the collar element is provided with a matching plurality of slots 20. Most preferably, four such protrusions with matching slots are utilized, at 90 degree spacing.

The safety nozzle assembly can be described as being in a locked position when the button element and the collar element are in the first rotational position with respect to each other and longitudinal movement between the elements is prevented. Most preferably, and as hereinafter described, rotational movement is also hindered when the elements are in the first rotational position.

Preferably, the plurality of radial protrusions on the button element slide along a lower surface 22 of the generally annular upper end wall of the collar element as the button element and the collar element are moved from the locked to an unlocked position. The radial protrusions on the button element become disengaged from the slots on the collar element when the button element and the collar element are in the unlocked position. Relative rotation between the pieces is employed to move the elements from the locked to unlocked position, and vice versa. However, since the collar element is usually fixed to the can, it is generally the button element which is rotated in practice.

The collar element preferably has a generally cylindrical inside wall 24 and the slots on the collar element are defined between the lower surface of the generally annular upper end wall of the collar element and a plurality of generally circumferentially extending ridge sections 26 positioned on the generally cylindrical inside wall of the collar element. A plurality of generally longitudinally extending slot end walls 28 connect one end of each ridge wall section with the generally annular upper end wall of the collar element. The radial protrusions on the button element contact the slot end walls when the button element and the collar element are in the first rotational position, and the ridge sections are spaced apart to permit the radial protrusions on the button element to pass between adjacent ridge wall sections.

In a preferred embodiment, a pair of opposed flaps 30 are formed in the generally cylindrical sidewall of the button at about a 90 degree angle to the nozzle outlet. The opposed flaps each have an upper end and a lower end and are attached to the button element at their upper ends. Each flap is manually depressible in a radially inward direction at its lower end and has at least one tooth 32 extending generally radially outwardly near its lower end. At least one opposed pair of teeth 34 extend generally radially inwardly from near the upper end of the collar element and engage the at least one tooth on the pair of flaps when the button element is in the first rotational position to strongly resist rotation between the collar element and the button element when in the engaged position. The teeth release engagement when the flaps are depressed. Rotation of the button element is thereby resisted unless the flaps are depressed, and the button element is essentially locked in a safe position. The teeth are preferably sawtooth shaped, so that they ride over each other easily when going into the locked position but resist riding over each other to become unlocked.

The nozzle assembly preferably further comprises a plurality of generally radially inwardly extending teeth 36 near the lower end of the collar element for snap fitting the collar element on a rolled connection. However, other methods of attachment, such as adhesive, could be used if desired.

It is also preferred to provide a plurality of vertically extending parallel ridges 38 on an outer surface of each flap to facilitate gripping the button element by the user, as well as to assist in identifying the location of the flaps by tactile means.

The nozzle assembly is preferably used in combination with an aerosol can, although it could also be used, with minor modifications, on a pump-type spray bottle. Generally speaking, the aerosol can will have an upper end closure having an outer peripheral portion and an inner central portion. The outer peripheral portion will generally be dome-shaped. The central inner portion will generally be disc shaped and attached to the outer peripheral portion with a rolled, generally circular connection. The collar element is snap fitted to the rolled, generally circular connection and carries the button element in operable association with the valve assembly of the can. A tube carried by either the button element or the valve assembly forms a flow path leading from the can.

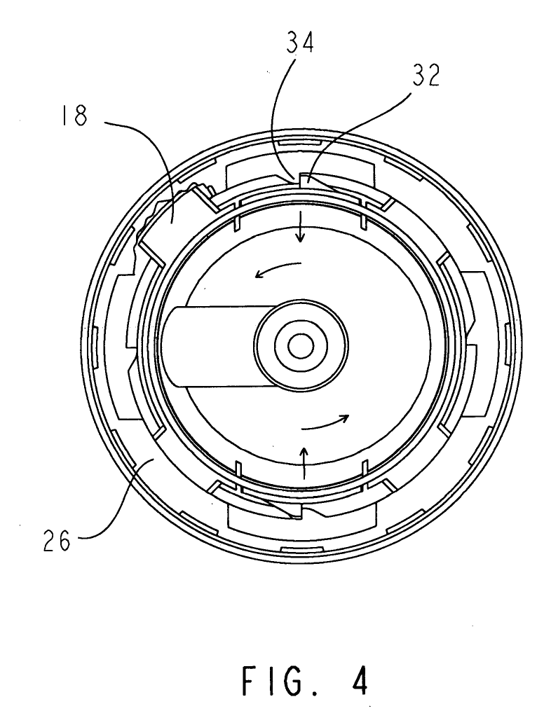

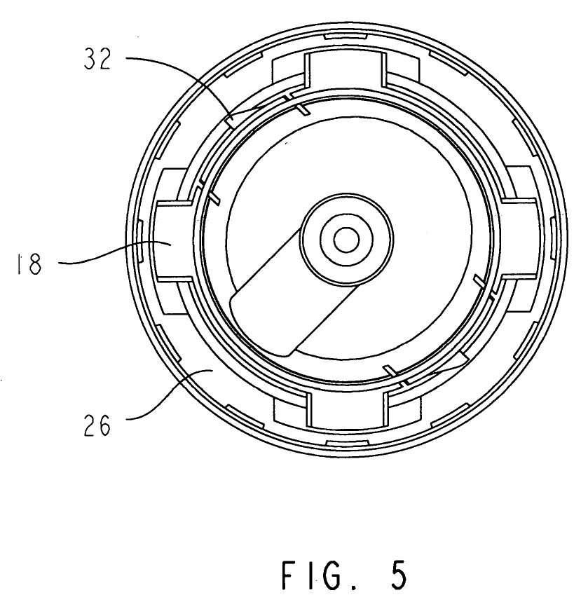

In use of a preferred embodiment of the invention, there is provided an aerosol can which carries the collar on its upper end, and the nozzle button is carried by the collar element in a locked position. The nozzle button is squeezed radially inwardly to disengage tooth means preventing relative rotational movement between the button and the collar, and then the button is rotated with respect to the collar to disengage tongue in groove means preventing relative longitudinal movement between the button and the collar. At that point, the button can be depressed downwardly toward the upper end of the can to discharge an aerosol from the can. See FIGS. 4 and 5. To secure the nozzle button, it is only necessary to rotate the button to override the one-way teeth. The nozzle element is biased upwardly to the limit set by the collar by the valve assembly of the can.

While certain preferred embodiments of the invention have been described herein, the invention is not to be construed as being so limited, except to the extent that such limitations are found in the claims.

What is claimed is:

1. A safety nozzle assembly for use on a pressurized aerosol container which has a generally centrally located valve assembly and a generally circular rim adjacent its upper end, said safety nozzle assembly comprising a collar element and a button element,
wherein the collar element has an open lower end for closely fitting over the rim, and an upper end which is partially closed by a generally annular upper end wall, said upper end defining a circular opening, and
wherein the button element has a generally cylindrical sidewall extending through the circular opening of the collar element, said button element having a flow passage therethrough having an axial portion leading to a nozzle inlet for connecting to the valve assembly and a radial portion leading to a nozzle outlet through which the aerosol spray may be directed by a user,
wherein the button element has a plurality of radial protrusions or circumferentially extending slots on its outer surface which are engagable with an opposite plurality of radial protrusions or circumferentially extending slots on an inner surface of the collar element to prevent relative longitudinal movement between the collar element and the button element when the button element and the collar element are in a first rotational position with respect to each other and the protrusions are engaged with the slots.

2. A safety nozzle assembly as in claim 1 wherein the button element is provided with a plurality of radial protrusions and the collar element is provided with a matching plurality of slots.

3. A safety nozzle assembly as in claim 2 wherein the safety nozzle assembly is in a locked position when the button element and the collar element are in the first rotational position with respect to each other.

4. A safety nozzle assembly as in claim 3 wherein the plurality of radial protrusions on the button element slide along a lower surface of the generally annular upper end wall of the collar element as the button element and the collar element are moved from the locked to an unlocked position.

5. A safety nozzle assembly as in claim 4 wherein the radial protrusions on the button element are disengaged from the slots on the collar element when the button element and the collar element are in the unlocked position.

6. A safety nozzle assembly as in claim 5 the collar element has a generally cylindrical inside wall and the slots on the collar element are defined between the lower surface of the generally annular upper end wall of the collar element and a plurality of generally circumferentially extending ridge sections positioned on the generally cylindrical inside wall of the collar element.

7. A safety nozzle assembly as in claim 6 wherein further comprising a plurality of generally longitudinally extending slot end walls connecting one end of each ridge wall section with the generally annular upper end wall of the collar element, wherein the radial protrusions on the button element contact the slot end walls when the button element and the collar element are in the first rotational position, and the ridge sections are spaced apart to permit the radial protrusions on the button element to pass between adjacent ridge wall sections.

8. A safety nozzle assembly as in claim 7 further comprising
a pair of opposed flaps formed in the generally cylindrical sidewall at about a 90 degree angle to the nozzle outlet, said opposed flaps each having an upper end and a lower end and being attached to the button element at their upper ends, each flap being manually depressible in a radially inward direction at its lower end and having at least one tooth extending generally radially outwardly near its lower end;
at least one opposed pair of teeth extending generally radially inwardly from near the upper end of the collar which engage the at least one tooth on the pair of flaps when the button element is in the first rotational position to strongly resist rotation between the collar element and the button element when in the engaged position, said teeth releasing engagement when the flaps are depressed;
whereby rotation of the button element is resisted unless the flaps are depressed.

9. A safety nozzle assembly as in claim 8 further comprising
a plurality of generally radially inwardly extending teeth near the lower end of the collar element for snap fitting the collar element on a rolled connection.

10. A safety nozzle assembly as in claim 8 further comprising a plurality of vertically extending parallel ridges on an outer surface of each flap to facilitate gripping the button element by the user.

11. A safety nozzle assembly as in claim 1, further comprising, in combination, an aerosol can,
said aerosol can having an upper end closure having an outer peripheral portion and an inner central portion, said outer peripheral portion being generally dome-shaped, and said central inner portion being generally disc shaped and being attached to the outer peripheral portion with a rolled, generally circular connection, said collar being snap fitted to said rolled, generally circular connection.

12. A method for releasing an aerosol nozzle button from a locked position, said button being carried by a collar positioned on an upper end of an aerosol can, said method comprising
squeezing the button radially inwardly to disengage tooth means preventing relative rotational movement between the button and the collar, and
rotating the button with respect to the collar to disengage the tongue in groove means preventing relative longitudinal movement between the button and the collar.

13. A method as in claim 12 further comprising
pushing the button downwardly toward the upper end of the can to discharge an aerosol from the can.
